(19) United States
(12) Patent Application Publication
(10) Pub. No.: US 2005/0120823 A1
(43) Pub. Date: Jun. 9, 2005

(54) Handlebar of electrically powered vehicle

(75) Inventor: Sonny Lin, Changhua City (TW)

Correspondence Address: TROXELL LAW OFFICE PLLC, SUITE 1404, 5205 LEESBURG PIKE, FALLS CHURCH, VA, 22041, US

(73) Assignee: Navajo Industrial Co., Ltd.

(21) Appl. No.: 10/726,656

(22) Filed: Dec. 4, 2003

(51) Int. Cl. B62K 21/12

(52) U.S. Cl. 74/551.1

(57) ABSTRACT

A handlebar structure for an electrically powered vehicle includes a front fork unit, a connector bar unit, and a handle unit wherein the front fork unit having a coupling section protruding at the top thereof is engaged with the connector bar unit having a retaining block adapted therein, and the handle unit is joined to an engaging cavity of the connector bar unit to form a two-stage handlebar adjustment structure. A top quick release unit is applied to clamp tight the handle unit for location at the connector bar thereto, and a bottom quick release unit is screwed up to the retaining block thereof to compress a spring element adapted at the retaining block therein. Via the top and bottom quick release units and a retaining teeth facet of the retaining block in meshing engagement with an adjusting teeth facet of the front fork unit, the handle unit can be precisely adjusted up or down, or swung back and forth into an angle, flexibly adjusting the position of the handle unit relative to that of an saddle thereof to match the length of hands and legs of a rider to provide a comfortable handlebar structure for the rider in the best riding posture. Besides, with the locating pin limited by the top quick-release unit thereof, the handle unit is securely adjusted at the engaging cavity of the connector bar unit therein without been detached there-from when pulled upwards by undue force, effectively protecting the handlebar structure thereof.

### BACKGROUND OF THE INVENTION

The present invention is related to a handlebar of an electrically powered vehicle, comprising a front fork unit, a connector bar unit, and a handle unit wherein the front fork unit having a coupling section protruding at the top thereof is engaged with the connector bar unit having a retaining block adapted therein, and the handle unit is joined to an engaging cavity of the connector bar unit; whereby, via a top and a bottom quick-release units and a retaining teeth facet of the retaining block in meshing engagement with an adjusting teeth facet of the front fork unit, the handle unit is easily adjusted up or down, or swung back and forth into an angle to form a two-stage handlebar adjustment structure, flexibly adjusting the position of the handle unit relative to that of a saddle thereof to match the length of hands and legs of a rider to provide a comfortable handlebar for the rider in the best riding posture.

A conventional handlebar for an electrically powered vehicle usually can be adjusted up or down according to the height of a rider. But with respect to the distance between the handlebar and a saddle of the vehicle, it can't be properly adjusted according to the length of hands and legs of a rider to provide a comfortable handlebar structure. Most of the time, the rider must either stretch stiffly or arched uncomfortably both arms to hold onto the handlebar thereof. Thus, the conventional saddle for an electrically powered vehicle can't fit to riders of different ages and sizes, failing to provide a comfortable handlebar structure for riders in the best riding posture.

### SUMMARY OF THE PRESENT INVENTION

It is, therefore, the primary purpose of the present invention to provide a handlebar of an electrically powered vehicle, comprising a front fork unit, a connector bar unit, and a handle unit wherein, via a retaining block having a spring element adapted therein and a retaining teeth facet defining one bottom side thereon to be securely meshed with an adjusting teeth facet of the front fork unit thereof, the handle unit joined to an engaging cavity of the connector bar unit can not only be adjusted up or down, but also swung back or forth into an angle to provide a two-stage adjustment handlebar structure, flexibly adjusting the position of the handle unit relative to that of a saddle of the electrically powered vehicle to match the length of hands and legs of a rider to provide a comfortable handlebar for the rider in the best riding posture.

It is, therefore, the secondary purpose of the present invention to provide a handlebar of an electrically powered vehicle wherein, via a top and a bottom quick release units and the retaining teeth facet of the retaining block thereof in meshing engagement with the adjusting teeth facet of the front fork unit thereof, the handle unit is precisely adjusted with ease and speed.

It is, therefore, the third purpose of the present invention to provide a handlebar structure for an electrically powered vehicle wherein, via a locating pin adapted at a support bar of the handle unit therein and limited by the top quick-release unit thereof, the handle unit is securely adjusted at the engaging cavity of the connector bar unit therein without been detached there-from to mar brake wires when improperly pulled upwards by undue force, securely protecting the handlebar structure thereof.

### BRIEF DESCRIPTION OF THE DRAWINGS

FIG. 1 is a perspective exploded view of the present invention.

FIG. 2 is a cross sectional view of the present invention in assembly.

FIG. 3 is a cross sectional view of the present invention in adjusting operation.

### DETAILED DESCRIPTION OF THE PREFERRED EMBODIMENTS

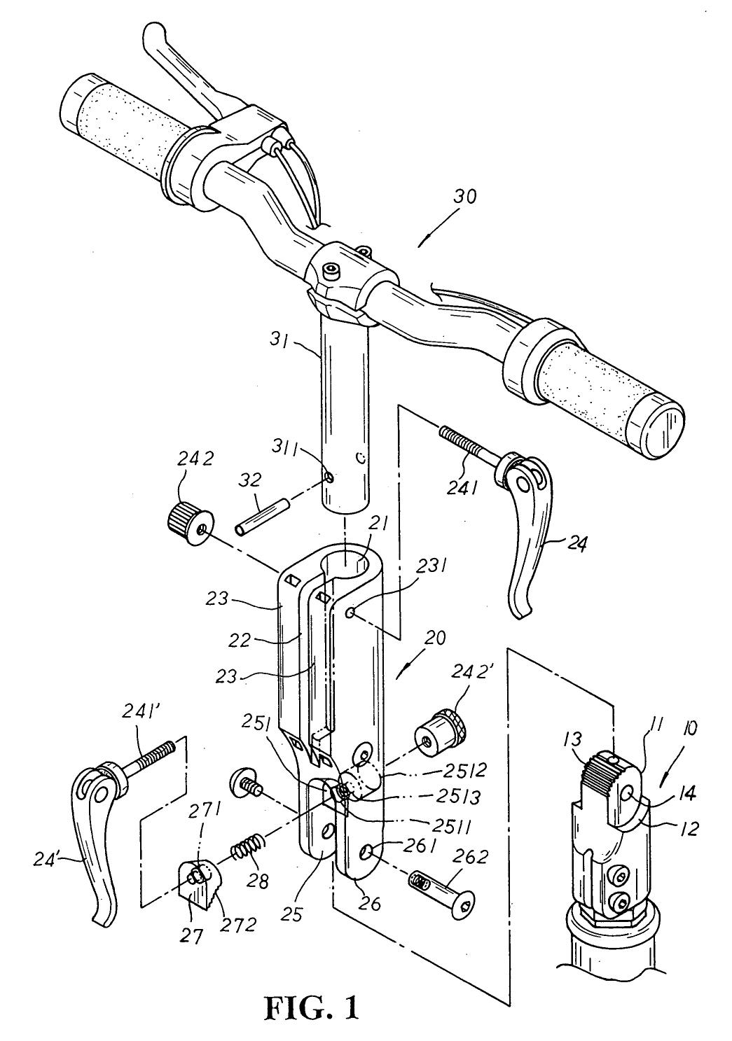

Please refer to FIG. 1. The present invention is related to a handlebar structure of an electrically powered vehicle, comprising a front fork unit 10, a connector bar unit 20, and a handle unit 30. The front fork unit 10 is made up of a coupling section 11 protruding at the top thereof, two arc guide facets 12 symmetrically indented at both lateral sides of the coupling section 11 thereof, an arc single direction adjusting teeth face 13 defining one top side of the coupling section 11 thereof, and an axial through hole 14 disposed at the middle section thereof. The connector bar unit 20 has an engaging cavity 21 disposed at the upper section thereof, a clamping recess 22 opened at one side of the engaging cavity 21 thereof, and a pair of clamping flanges 23 symmetrically extending at both sides of the clamping recess 22 thereof. A pivoting hole 231 is disposed at the upper section of the clamping flanges 23 thereof for a screw rod 241 of a top quick-release unit 24 to be led there-through and registered with an upper screw nut 242. The connector bar unit 20 also includes an inverted U-shaped limiting slot 25 defining the lower section thereof, two pivoting plates 26 extending downwards at both sides of the limiting slot 25 thereof, and a pivoting pin hole 261 disposed at the lower section of each pivoting plate 26 thereof for a pivot pin 262 to be led and engaged therewith. The upper section of the limiting slot 25 thereof has a securing plane 251 disposed at one side thereon, an inner annular sleeve groove 2511 indented at one side of the securing plane 251 thereon, and an outer annular sleeve groove 2512 communicating with the inner annular sleeve groove 2511 via a step-wise through hole 2513 through which a screw bolt 241′ of a bottom quick-release unit 24′ is led there-through to be registered with a lower screw nut 242′. A retaining block 27, properly matched to the securing plane 251 thereof, is provided with a step-wise retaining hole 271 for a spring element 28 to be adapted therein, and an arc single direction retaining teeth facet 272 defining the bottom side thereof. The handle unit 30 is made up of a support bar 31 having a fixing through hole 311 disposed at the lower section thereon for a locating pin 32 to be adapted and engaged therewith.

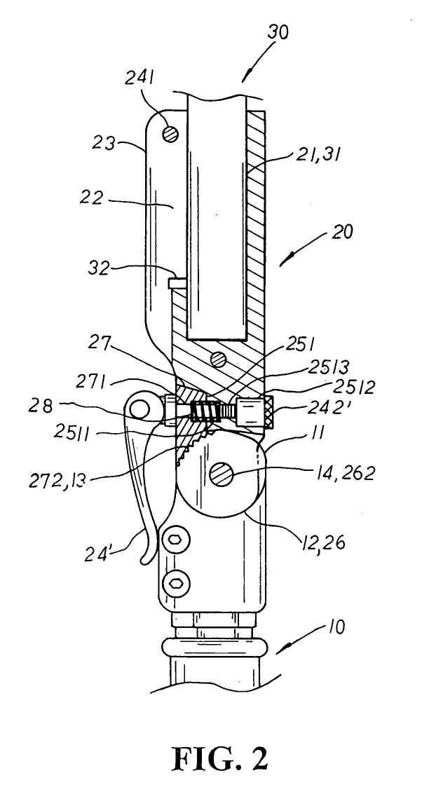

Please refer to FIG. 2. In assembly, the spring element 28 is adapted to the inner annular sleeve groove 2511 by one end and engaged therewith before the step-wise retaining hole 271 of the retaining block 27 is registered with the other end of the spring element 28 for the retaining block 27 thereof to be abutted against the securing plane 251 of the limiting slot 25 thereof. The screw bolt 241′ of the bottom quick-release unit 24′ is axially applied from the outer side of the retaining block 27 and consecutively led through the step-wise retaining hole 271, the inner annular sleeve groove 2511, the step-wise through hole 2513, and the outer annular sleeve groove 2512 thereof in a sequence to be securely screwed up to the lower screw nut 242′, pressing tight the securing block 27 thereof so as to compress the spring element 28 adapted therein. The limiting slot 25 of the connector bar unit 20 is led from top to bottom to be engaged with the coupling section 11 of the front fork unit 10 with the pivoting pin holes 261 of the pivoting plates 26 thereof correspondingly matched and juxtaposed with the axial through hole 14 thereof for the pivot pin 262 to be led there-through and pivotally fixed thereto via a screw. Thus, the retaining teeth facet 272 of the retaining block 27 is fixedly meshed with the adjusting teeth facet 13 of the coupling section 11, sustaining the connector bar unit 20 thereof to extend upright at the front fork unit 10 thereon. The support bar 31 of the handle unit 30 is then adapted to the engaging cavity 21 of the connector bar unit 20 therein in sleeve engagement till the locating pin 32 thereof abutted against the bottom side of the clamping recess 22 thereon. The screw rod of the top quick-release unit 24 is led through the pivoting holes 231 of the two clamping flanges 23 and securely fixed to the upper screw nut 242 thereof, clamping tight the support bar 31 at the engaging cavity 21 therein for location thereby to complete the assembly of the present invention.

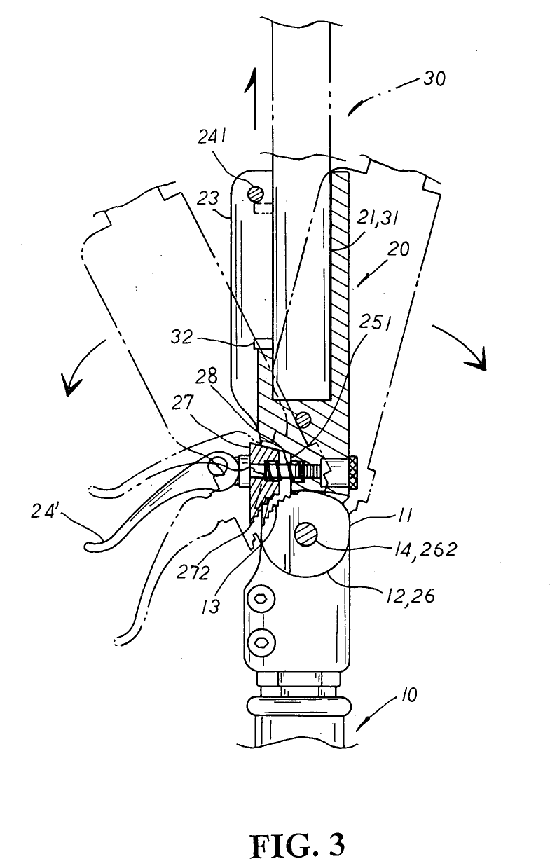

Please refer to FIG. 3. In adjusting operation thereof, the top quick-release unit 24 is released for the support bar 31 of the handle unit 30 to be moved up or down at the engaging cavity 21 therein to adjust the height of the handle unit 30 thereof. Besides, the top quick-release unit 24 attached to the connector bar unit 20 thereof can also be pulled upwards to release the compressed spring element 28, bouncing outwards the retaining block 27 thereof and detaching the retaining teeth facet 272 thereof from the meshing engagement with the adjusting teeth facet 13 thereof. The connector bar unit 20 can then be bent either back or forth with the pivoting plates 26 thereof swung along the arc guide facets 12 of the front fork unit 10 thereof to slant the handle unit 30 thereof into an angle therewith. Thus, no matter adjusted high or low, the handle unit 30 can also be adjusted into an angle relative to the position of a saddle of the vehicle so as to properly match the length of hands and legs of a rider to provide a comfortable handlebar structure for the rider in the best riding posture. When the bottom quick-release unit 24′ is securely screwed up again, the retaining block 27 thereof will abut tight against the securing plane 251 thereof, compressing the spring element 28 and relocating the retaining teeth facet 272 to be securely meshed with the adjusting teeth facet 13 thereof in an easy and fast manner. Moreover, the handle unit 30 is adjusted up or down at the engaging cavity 21 therein via the locating pin 32 limited by the screw rod 241 of the top quick-release unit 24. When the handle unit 30 is improperly pulled upwards by undue force, the locating pin 32 will be stopped by the screw rod 241 thereof, preventing the handle unit 30 from detaching from the connector bar unit 20 and ripping off brake wires of the vehicle thereof, effectively protecting the handlebar structure thereof.

1. A handlebar structure of an electrically powered vehicle, comprising a front fork unit, a connector bar unit, and a handle unit wherein the front fork unit is coupled with the connector bar unit, and the handle unit is joined to the connector bar unit to form a two-stage handlebar adjustment structure; the present invention being characterized by that,
the front fork unit being made up of a coupling section protruding at the top thereof, two arc guide facets symmetrically indented at both lateral sides of the coupling section thereof, an arc single direction adjusting teeth face defining one top side of the coupling section thereof, and an axial through hole disposed at the middle section thereof;
the connector bar unit having an engaging cavity disposed at the upper section thereof, a clamping recess opened at one side of the engaging cavity thereof, and a pair of clamping flanges symmetrically extending at both sides of the clamping recess thereof; a pivoting hole being disposed at the upper section of the clamping flange thereof for a screw rod of a top quick-release unit to be led there-through and registered with an upper screw nut; the connector bar unit also including an inverted U-shaped limiting slot defining the lower section thereof, two pivoting plates extending downwards at both sides of the limiting slot thereof, and a pivoting pin hole disposed at the lower section of each pivoting plate thereof for a pivot pin to be led and engaged therewith; the upper section of the limiting slot thereof having a securing plane disposed at one side thereon, an inner annular sleeve groove indented at one side of the securing plane thereon, and an outer annular sleeve groove communicating with the inner annular sleeve groove via a step-wise through hole through which a screw bolt of a bottom quick-release unit is led there-through to be registered with a lower screw nut; a retaining block, properly matched to the securing plane thereof, having a step-wise retaining hole disposed thereon for a spring element to be adapted therein, and an arc single direction retaining teeth facet defining the bottom side thereof;
the handle unit being made up of a support bar having a fixing through hole disposed at the lower section thereon for a locating pin to be adapted and engaged therewith.
